(19) United States
(12) Patent Application Publication
(10) Pub. No.: US 2005/0240997 A1
(43) Pub. Date: Oct. 27, 2005

(54) ID collection and management apparatus, method and program of computer

(76) Inventors: Kenichi Shimooka, Yokohama (JP); Masayuki Yamamoto, Sagamihara (JP); Hiroshi Furukawa, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/887,845

(22) Filed: Jul. 12, 2004

(30) Foreign Application Priority Data
Apr. 27, 2004 (JP) 2004-131241

(51) Int. Cl. H04L 9/00; H04L 9/32; G06F 11/30; G06F 12/14

(52) U.S. Cl. 726/18

(57) ABSTRACT

The IDs of a computer to be used for setting a storage controller are acquired and managed. An ID collection and management apparatus manages the IDs of the computer for a computer system comprising a storage volume assigned for storing data, at least one computer provided with a data port which reads or writs data in the storage volume, and a storage controller which controls the communications between the computer and the storage volume. The ID collection and management apparatus acquires an ID-A or the ID of the computer from the data port and an ID-B or the ID of the computer from the storage controller, and manages the corresponding relation between the ID-A and the ID-B for each computer.

This application claims a priority based on Japanese Patent Application No. 2004-131241 filed on Apr. 27, 2004, the entire contents of which are incorporated herein by reference for all purpose.

### BACKGROUND

It is related with a technique which acquires and manages the identifications of a computer used for setting a storage controller.

The SAN (Storage Area Network) and other computer systems, in which a large-scaled storage subsystem is connected directly with a network, have assumed an important position.

In the SAN, a plurality of computers utilizes the storage volume in the storage subsystem connected with the SAN. For this utilization, there is a configuration, in which the data ports of the computers are connected either directly or through a communication relay unit with the data ports of the storage subsystem.

On the other hand, the storage subsystem has a storage controller which makes an access control from the computer to the storage subsystem or an access resource prioritizing control (e.g., Japanese Patent Laid-Open Publication No. H10-333839 or No. 2002-108567).

Here, the access control function is to inhibit the access to a specific storage volume from computers other than a specific one, and the access resource prioritizing function is to limit the access resource bandwidth from a specific computer, to a predetermined or smaller value.

The access control function or the access resource prioritizing control function is set for each computer. Therefore, an ID (identification) of the computer is needed as the setting parameters of the case, in which those controls are made in the storage controller. The setting parameters are individually stored in an access control table, an access resource prioritized table and soon. This ID is exemplified by a numerical string of 64 bits, as called the WWN (World Wide Name) in the FC (Fibre Channel).

The SAN is frequently configured of a single protocol such as the FC. In this environment, the ID of the computer can be acquired from the data port of the computer and used as it is as the setting parameter for the storage controller. A manager of the SAN recognizes the aforementioned ID of the computer, when the system is configured, and sets the ID in each storage controller.

In the environment having many computers, however, a long time is required for the setting, and the risk of making input mistakes is high. As one solution for this problem, there is a storage controller (as referred to Japanese Patent Laid-Open No. 2001-337863, for example), in which the ID of the computer contained in a frame coming from that computer is extracted, held and displayed.

### SUMMARY

However, the environment, in which the protocols to be used on the computer side and the storage subsystem side are different, has been created in recent years such that the iSCSI (internet Small Computer System Interface) or the protocol to be applied to the SAN is standardized. For example, the computer side uses the iSCSI whereas the storage subsystem side uses the FC, and the communication relay unit is configured by the FC/IP (Fibre Channel/Internet Protocol) router. In this environment, the ID of the computer to be set in the storage controller is that of the FC such as the WWN configured in the FC/IP router. On the other hand, the ID to be acquired from the data port of the computer is that of the iSCSI such as iSCSI Name.

In the case that different protocols exist in the SAN, the ID of the computer itself and the ID of the computer to be recognized by the storage subsystem are different. In other words, the ID obtained from the computer and the ID of the computer to be set in the storage controller are different. Therefore, the ID can neither be acquired from the data port of the computer nor be used as it is as the parameter to be set in the storage controller.

Regardless of whether the protocols on the two sides of the communication relay unit are different or not, the ID may be converted in the communication relay unit. The conversion of the ID is set in a relay table included in the communication relay unit. The computer and the storage subsystem are connected according to the setting of that relay table.

In this complicated environment having a plurality of communication relay units, it is seriously difficult for the manager to grasp all the settings thereby to set the storage controller correctly.

Depending on the setting of the relay table, moreover, the data ports of the different computers may be assigned the same ID and connected with the data port of the storage subsystem.

The storage subsystem side can recognize only one ID per one computer. In that case, it is impossible to discriminate the different computers assigned the same ID by the computer relay unit. It is, therefore, impossible to set the access control function or the access resource prioritizing function for each computer. If that function is set in one of the different computers assigned the same ID, this setting is reflected on the remaining ones of the different computers assigned the same ID. In other words, side effects other than those desired by the manager may occur in dependence upon the setting of the communication relay unit.

One embodiment of the present invention is made taking the above-described situations into consideration and has an object to set the access control function and the access resource prioritizing function conveniently without any ID conversion information in the communication relay unit, in a computer system in which a computer and a storage subsystem are connected through a communication relay unit having a function to convert the ID.

In order to achieve the above-specified object, the ID collection and management apparatus of one embodiment of the present invention collects a first ID which can be recognized by the computer itself, and a second ID which is recognized as the ID of the computer by the storage subsystem (referred to as “the storage system”, also), and manages the collected IDs in a corresponding manner.

More specifically, a management apparatus which manages the identifiers of computers in a computer system including the computers and a storage subsystem which provides the computers with a storage volume, comprising: a first ID acquisition unit which acquires first IDs which are IDs of a data port for the computers to transmit/receive data with the storage volume; a second ID acquisition unit which acquires second IDs to be recognized as the IDs of the computers by the storage subsystem; and an ID management unit which manages the first IDs and the second IDs in a corresponding manner for each of the computers.

According to above specified embodiment of the management apparatus, in a computer system in which a computer and a storage subsystem are connected through a communication relay unit having a function to convert the ID, it is possible to set functions requiring the ID of the computer such as an access control function and an access resource prioritizing function conveniently without any ID conversion information in the communication relay unit.

### BRIEF DESCRIPTION OF THE DRAWINGS

FIG. 1 is a system configuration diagram of a computer system of a first embodiment;

FIG. 2 is a block diagram showing an internal configuration of a computer of the first embodiment;

FIG. 3 is a block diagram showing an internal configuration of a communication relay unit of the first embodiment;

FIG. 4 is a diagram showing one example of a relay table of the first embodiment;

FIG. 5 is another system configuration diagram of the computer system of the first embodiment;

FIG. 6 is a block diagram showing an internal configuration of a storage subsystem of the first embodiment;

FIG. 7 is a diagram showing one example of an access control table of the first embodiment;

FIG. 8 is a diagram showing one example of an access resource prioritized table of the first embodiment;

FIG. 9 is a block diagram showing an internal configuration of an ID collection and management apparatus of the first embodiment;

FIG. 10 is a sequence diagram of an ID collection processing of the first embodiment;

FIG. 11 is a diagram showing one example of an ID table of the first embodiment;

FIG. 12 is a diagram showing one example of a display screen displaying the contents of the ID table of the first embodiment thereby to notify the usage of the same ID;

FIG. 13 is a processing flow of a setting of a storage controller of the first embodiment;

FIG. 14 is a diagram showing one example of an error screen of the first embodiment;

FIG. 15 is another processing flow of a setting of a storage controller of the first embodiment;

FIG. 16 is a diagram showing one example of a warning screen of the first embodiment;

FIG. 17 is a system configuration diagram of a computer system of a second embodiment;

FIG. 18 is a processing flow of a setting of a storage controller in the second embodiment;

FIG. 19 is a diagram showing one example of an input acceptance and message display screen in the first embodiment; and

FIG. 20 is a block diagram showing an internal configuration of a communication relay unit of the second embodiment.

### DESCRIPTION OF THE PREFERRED EMBODIMENTS

### First Embodiment

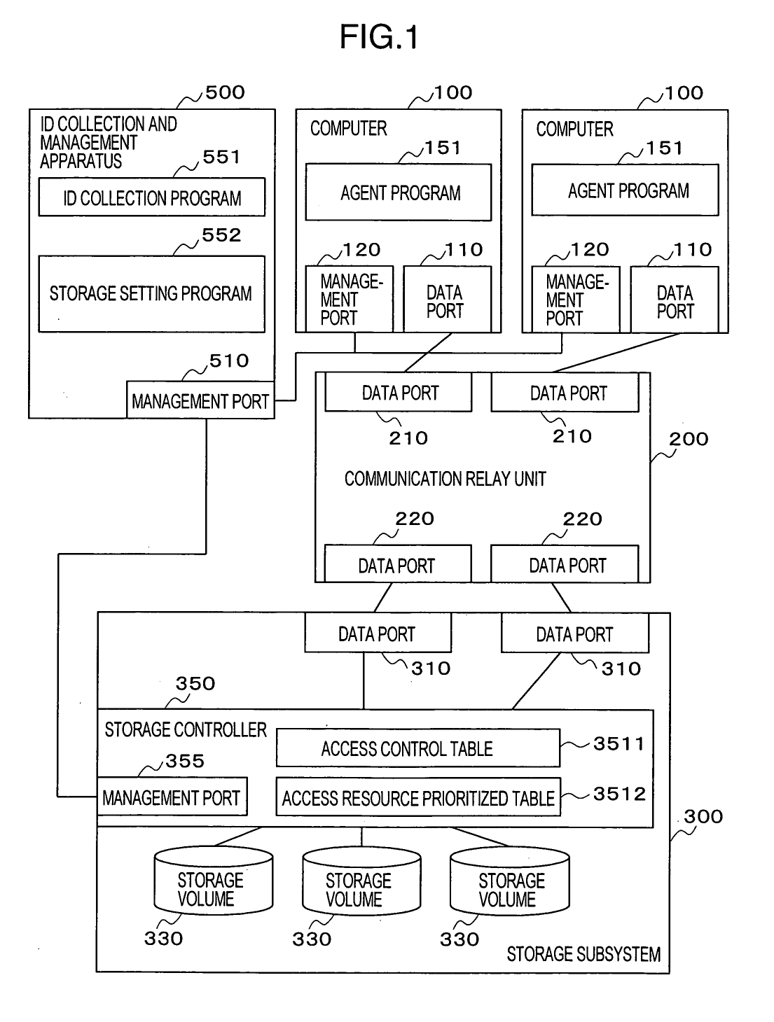

FIG. 1 is a system configuration diagram of a computer system of a first embodiment, to which the present invention is applied.

The computer system of this embodiment is provided with a computer 100, a communication relay unit 200, a storage subsystem 300 and an ID collection and management apparatus 500.

In this embodiment, the network between the communication relay unit 200 and the computer 100 will be described on the case using an iSCSI (internet Small Computer System Interface) protocol. On the other hand, the network between the communication relay unit 200 and the storage subsystem 300 will be described on the case using an FC (Fibre Channel) protocol. However, the protocol used is not limited to this invention.

Here, the ID collection and management apparatus 500 is one independent apparatus in this embodiment by, but may be disposed in the computer 100 or assembled in the communication relay unit 200 or the storage subsystem 300.

The individual configuration components of the computer system of this embodiment will be described with reference to FIG. 1 and FIG. 2 to FIG. 9.

The computer 100 is an information processing device which reads or writes the data of the storage volume 330 of the storage subsystem 300. In this embodiment, the number of computers 100 is not limited.

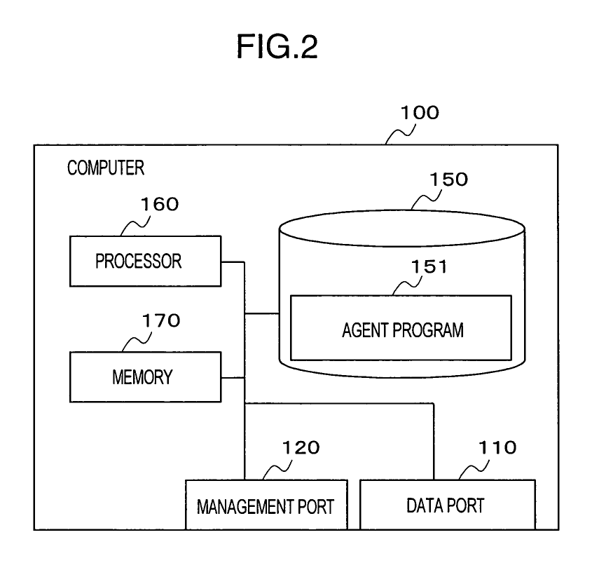

FIG. 2 is a block diagram showing an internal configuration of the computer 100.

The computer 100 is provided with a data port 110 acting as an interface with the storage subsystem 300, a management port 120 acting as an interface with the ID collection and management apparatus 500, a storage volume 150 storing an agent program 151 which realizes an agent function to acquire an ID, a processor 160, and a memory 170.

The function of the agent is realized when the processor 160 loads the memory 170 with the agent program 151 and executes the agent program 151. This agent program 151 may be started either when an access is made from the ID collection and management apparatus 500 or in advance.

In this embodiment, the agent program 151 is stored in the storage volume 150 included in the computer 100, but its storage is not limited therein. For example, the agent program 151 maybe stored in the storage volume of the storage subsystem 300, the ID collection and management apparatus 500 or another computer 100, or in an independent storage volume. In these cases, the computer 100 may be configured by omitting the storage volume 150.

The computer 100 may also be conceived to have a plurality of data ports 110. Each data ports 110 may be handled as one computer 100 in this embodiment. In this case, those computers 100 may share any or all of the management port 120, the storage volume 150, the agent program 151, the processor 160 and the memory 170.

The number of the management port 120 is not limited. Moreover, the data port 110 and the management port 120 are described as different ones in this embodiment, but one port may perform the roles of the two.

The communication relay unit 200 is a device which relays the connection between the computer 100 and the storage subsystem 300. The communication relay unit 200 of this embodiment is configured by an FC/IP (Fibre Channel/Internet Protocol) router, for example.

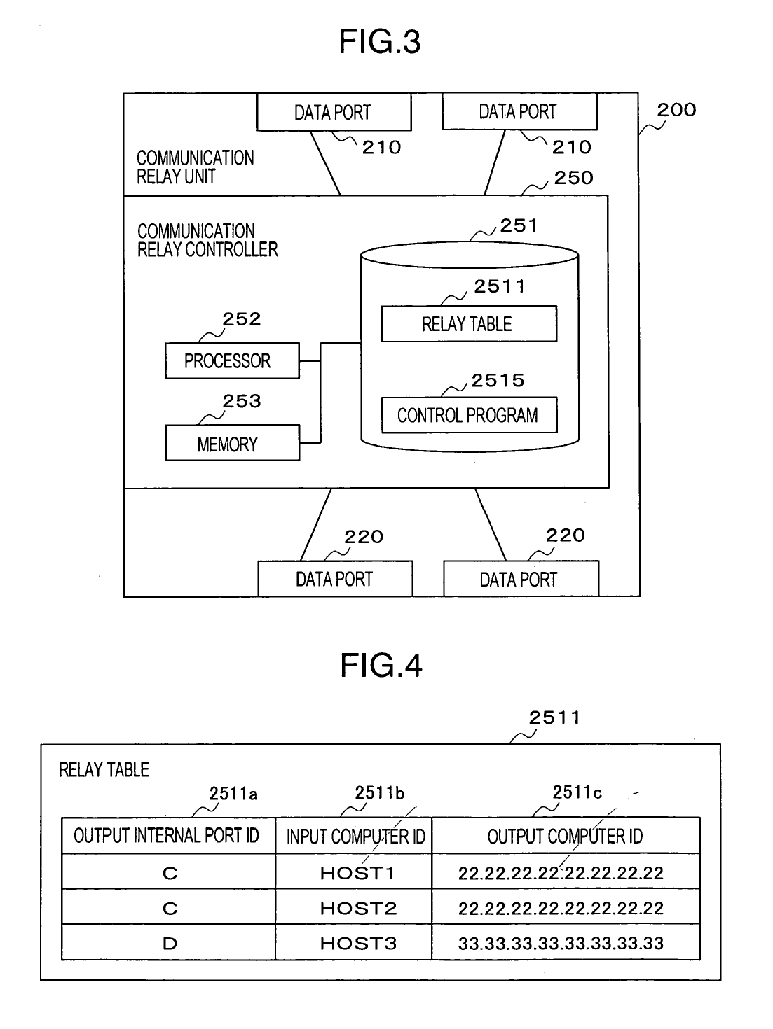

FIG. 3 is a block diagram showing an internal configuration of the communication relay unit 200.

The communication relay unit 200 is provided with a data port 210 to be connected with the computer 100, a data port 220 to be connected with the storage subsystem 300, and a communication relay controller 250 which controls the connections of the data ports 210 and 220.

The communication relay unit 200 is provided with the data port 210 to be connected with the computer 100, and the data port 220 to be connected with the storage subsystem 300. The data ports 210 and 220 are shown by two in every drawing, but are not limited in their number.

The communication relay controller 250 is provided with a storage volume 251, a processor 252 and a memory 253.

The storage volume 251 stores a relay table 2511 which holds the information on the conversion of IDs, and a control program 2515 which controls the connections of the data ports 210 and 220 and the conversions of IDs in transmission/reception frames.

Here, the functions of the control program 2515 are realized such that the processor 252 loads the memory 253 with them and executes them.

One example of the relay table 2511 is shown in FIG. 4.

As shown in FIG. 4, the relay table 2511 is provided with an output internal port ID field 2511a which stores the IDs for identifying the data port 220 to be connected with the storage subsystem 300 of the communication relay unit 200, an input computer ID field 2511b which stores the ID of and from the computer 100, and an output computer ID field 2511c which stores the ID when an access is made to the storage subsystem 300.

In accordance with the setting of the relay table 2511, the control program 2515 controls and relays the conversion of IDs in the transmission/reception frames between the computer 100 and the storage subsystem 300. In the example of FIG. 4, the iSCSI Name is set as the ID of the computer 100, and the WWN of the FC is set as the ID at the time of an access to the storage subsystem 300.

In FIG. 4, the first entry indicates the conversion of the ID (iSCSI Name) called “HOST1” on the side of the computer 100 into the ID (WWN) called “22.22.22.22.22.22.22.22”. Moreover, the second entry indicates the conversion of the ID (iSCSI Name) called “HOST2” on the side of the computer 100 also into the ID (WWN) called “22.22.22.22.22.22.22.22”. From the information stored in those entries, it is found that the computers 100 specified with the IDs “HOST1” and “HOST2” are assigned the same ID “22.22.22.22.22.22.22.22”.

The data ports 210 and 220 are described as the different ones in this embodiment, but one port may play the roles of the two.

Here, a plurality of communication relay units 200 may be provided. Moreover, a plurality of communication relay units 200 may be connected in multiple stages.

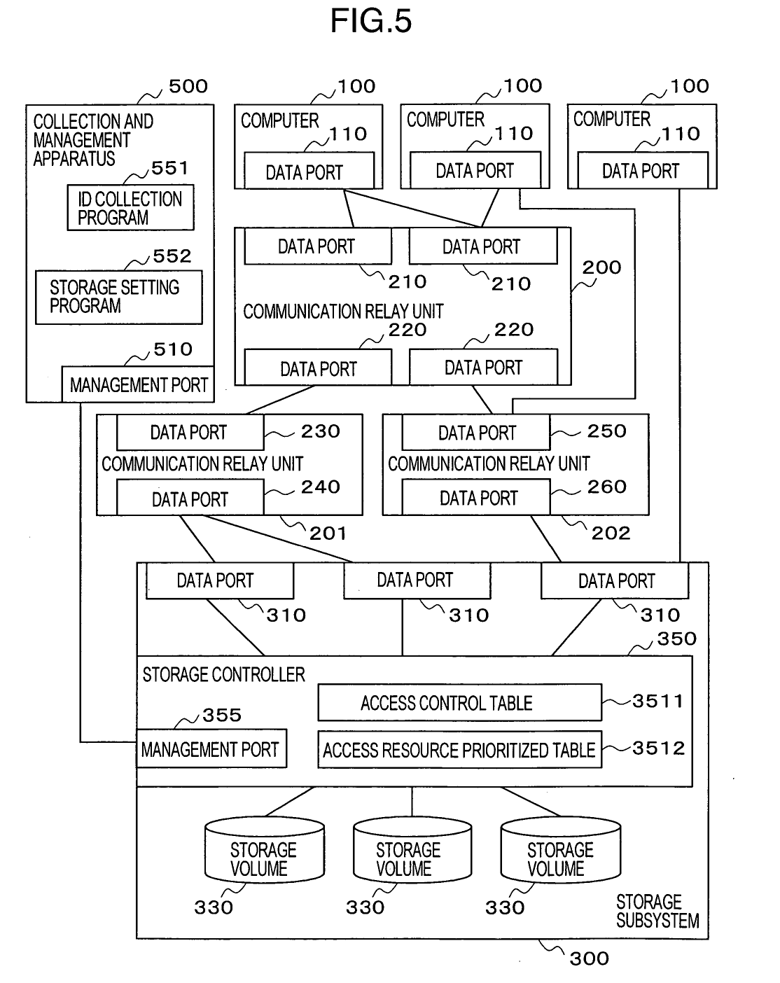

One example of the computer system provided with a plurality of communication relay units 200 connected in multiple stages is shown in FIG. 5. In FIG. 5, all the communication relay units 200, 201 and 202 are provided with functions like those of the aforementioned communication relay unit 200. Here in the computer system, the individual communication relay units 200, 201 and 202 may be connected in series like the communication relay units 200 and 201 or in parallel like the communication relay units 200 and 202, or the series and parallel connections may be mixed.

In a configuration, moreover, the computer 100 and the storage subsystem 300 may be connected directly not through the communication relay unit 200.

The storage subsystem 300 is a device which stores data. The number of the storage subsystem 300 in this computer system is not limited.

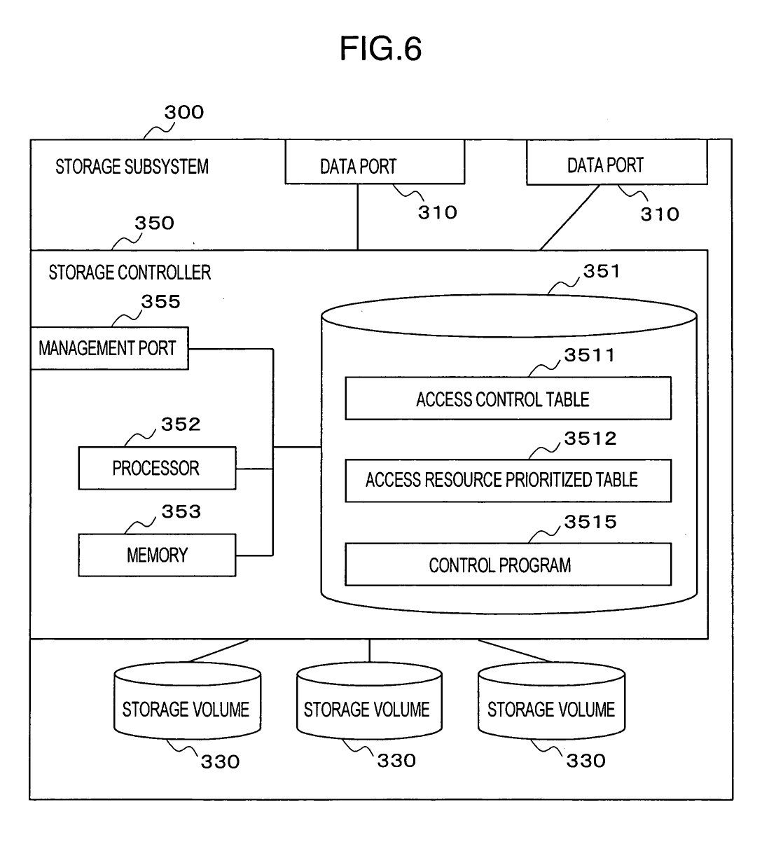

FIG. 6 is a block diagram showing an internal configuration of the storage subsystem 300.

The storage subsystem 300 is provided with data ports 310 acting as an interface with the computer 100, storage volumes 330 which stores data, and a storage controller 350 which controls the accesses to the data ports 310 and the storage volumes 330.

The storage controller 350 is provided with; a storage volume 351 which stores an access control table 3511 which holds the management data to make an access control, an access resource prioritized table 3512 which holds the management data to make an access resource prioritizing control, and a control program 3515 which controls the accesses of the data ports 310 and the storage volumes 330; a processor 352; a memory 353; and a management port 355 acting as an interface with the ID collection and management apparatus 500.

The access controls and the access resource prioritizing controls of the data ports 310 and the storage volumes 330 are realized when the control program 3515 is loaded in the memory 353 and executed by the processor 352. The control program 3515 may be started either when an access is made from the ID collection and management apparatus 500 or the computer 100, or may be started in advance.

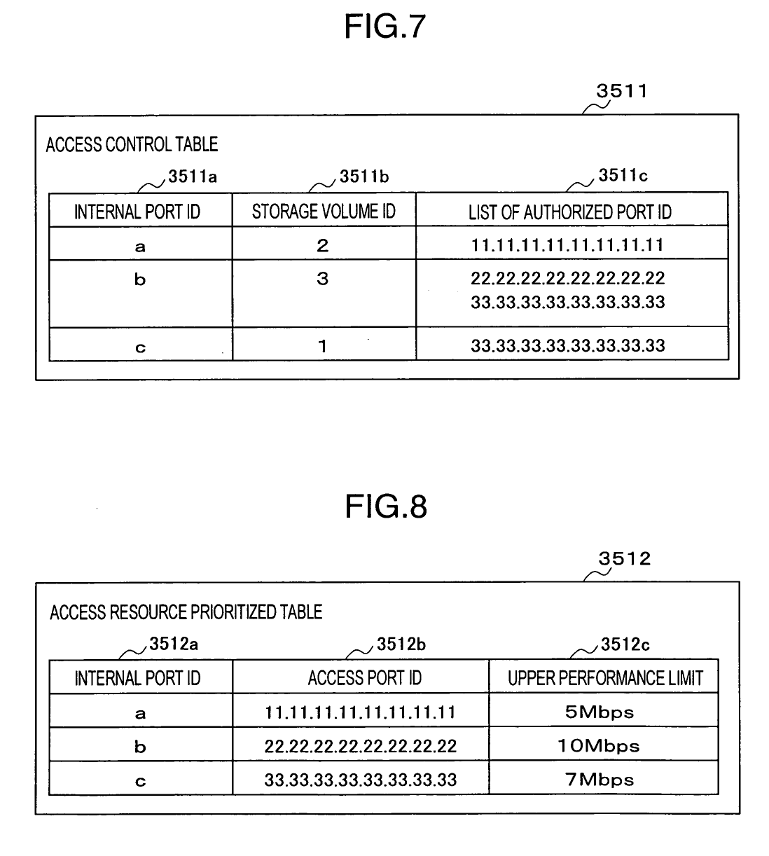

One example of the access control table 3511 is shown in FIG. 7.

As shown in FIG. 7, the access control table 3511 is provided with an internal port ID field 3511a which stores IDs to identify the data ports 310 of the storage subsystem 300, a storage volume ID field 3511b which stores IDs to identify storage volumes to be connected through the individual data ports 310, and a field 3511c which stores a list of authorized port IDs storing identifiers for identifying the data ports 110 of the computers 100 authorized to make an access to that storage volume.

In the example of FIG. 7, the WWN of the FC is set as the identifier of the data ports 110 of the computers 100. For example, the second entry indicates that the data port 110 of the computer 100 having the IDs (WWN) of “22.22.22.22.22.22.22.22” or “33.33.33.33.33.33.33.33” is authorized to make an access to the storage volume 330 having the storage volume ID “3” through the data port 310 of the storage subsystem 300 having the internal port ID “b”. It is also indicated that the data port 110 of the computer 100 having the ID (WWN) of “11.11.11.11.11.11.11.11” is not authorized to make an access thereto.

The control program 3515 controls the access from the computer 100 in accordance with the setting of the access control table 3511.

Next, one example of the access resource prioritized table 3512 is shown in FIG. 8.

As shown in FIG. 8, the access resource prioritized table 3512 is provided with an internal port ID field 3512a which stores IDs to identify the data ports 310 of the storage subsystem 300, an access port ID field 3512b which stores IDs which for identifying the data ports 110 of the computers 100, and an upper performance limit storage volume 3512c which stores the upper limit of the communication band such as of the transfer rate, which is authorized between the data port 310 having the ID stored in the internal port ID field 3512a and the data port 110 of the computer 100 having the ID stored in the access port ID field 3512b.

In the example of FIG. 8, the WWN of the FC is set as the ID of the data ports 110 of the computers 100. For example, the first entry indicates that the communication from the data port 110 of the computer 100 having the identifier “11.11.11.11.11.11.11.11” to the data port 310 of the storage subsystem 300 having the internal port ID “a” is authorized up to 5 Mbps at the maximum.

In accordance with the setting of the access resource prioritized table 3512, the control program 3515 controls the communication band with the computer 100.

Here, the storage controller 350 is in the storage subsystem 300 in this embodiment but may be an independent device.

Any or all of the access control table 3511, the access resource prioritized table 3512 and the control program 3515 are stored in the storage volume 351 included in the storage controller 350 in this embodiment, but may also be stored in the storage volume 330. In this case, the storage controller 350 may be configured by omitting the storage volume 351.

The number of the management port 355 is not limited. Also, the number of the data port 310 is not limited. The data port 310 and the management port 355 are described as different ones in this embodiment, but one port may play the roles of the two. The number of the storage volume 330 is not limited.

Here will be described the ID collection and management apparatus 500. This ID collection and management apparatus 500 collects and manages that information for identifying the computers 100, which is essential for the access control and the access resource prioritizing control. In this embodiment, the ID collection and management apparatus 500 collects the ID (WWN) of the FC of the computer 100, which cannot be known on the side of the computer 100, from the storage subsystem 300, and manages the ID in a manner to correspond to the ID (iSCSI Name) of the iSCSI collected from the data ports of the computer 100.

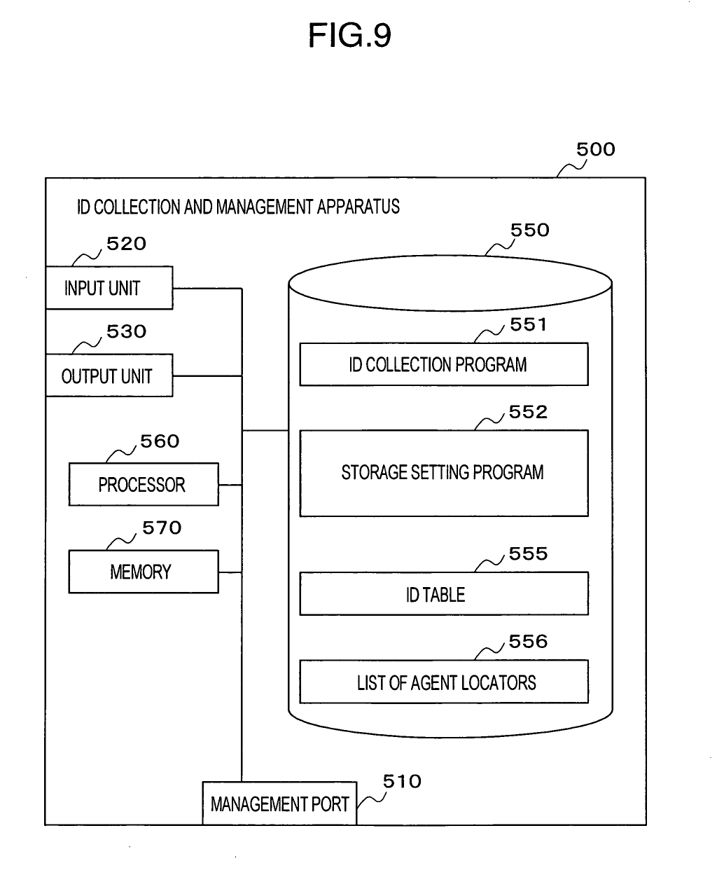

FIG. 9 is a block diagram showing an internal configuration of the ID collection and management apparatus 500.

The ID collection and management apparatus 500 is provided with a management port 510 acting as an interface with the computer 100 and the storage controller 350, an input unit 520, an output unit 530, a storage volume 550, a processor 560 and a memory 570.

The storage volume 550 stores an ID collection program 551 which collects the IDs, a storage setting program 552 which sets the storage controller 350, an ID table 555 which holds the ID of the computer 100, and a list of agent locators 556 which holds the information to make an access to the agent program 151.

The ID collection program 551 and the storage setting program 552 are loaded in the memory 570 by the processor 560 and executed to realize their functions.

The information to be held by the list of agent locators 556 may be either inputted through the input unit 520 by the manager of this system or received at the starting time or periodically from the agent program 151 included in each computer 100 through the management port 120 of the computer 100 and the management port 510 of the ID collection and management apparatus 500.

Here, any or all of the ID collection program 551, the storage setting program 552, the ID table 555 and the list of agent locators 556 are stored in the storage volume 550 in this embodiment, but may also be stored in the storage volume 330 of another computer or the storage subsystem 300 or in an independent storage medium. In this case, the ID collection and management apparatus 500 can be configured by omitting the storage volume 550.

The number of the management port is not limited. The interface with the computer 100 and the interface with the storage controller 350 may also be realized by different management ports.

The input unit 520 and the output unit 530 are in the ID collection and management apparatus 500 in this embodiment, but may also be in another computer connected with the ID collection and management apparatus 500 through a network. The ID collection and management apparatus 500 may also be configured either as a dedicated apparatus or as a general information processing apparatus such as a PC (Personal Computer). Moreover, the ID collection program 551 and the storage setting program 552 may also be packaged in different apparatus.

Here will be described the ID collection processing in this embodiment. This ID collection processing is realized when the processor 560 loads the ID collection program 551 in the memory 570 and executes the same program.

The ID collection program 551 acquires two IDs by using the agent locating function of the computer 100. One is the ID which is acquired by the ordinary method directly from the data port 110 of the computer 100. The other is the ID of that computer 100, which is stored in the reply frame obtained when an access is made to the storage subsystem 300 from the computer 100.

The ID collection program 551 manages the two IDs acquired, in a corresponding manner.

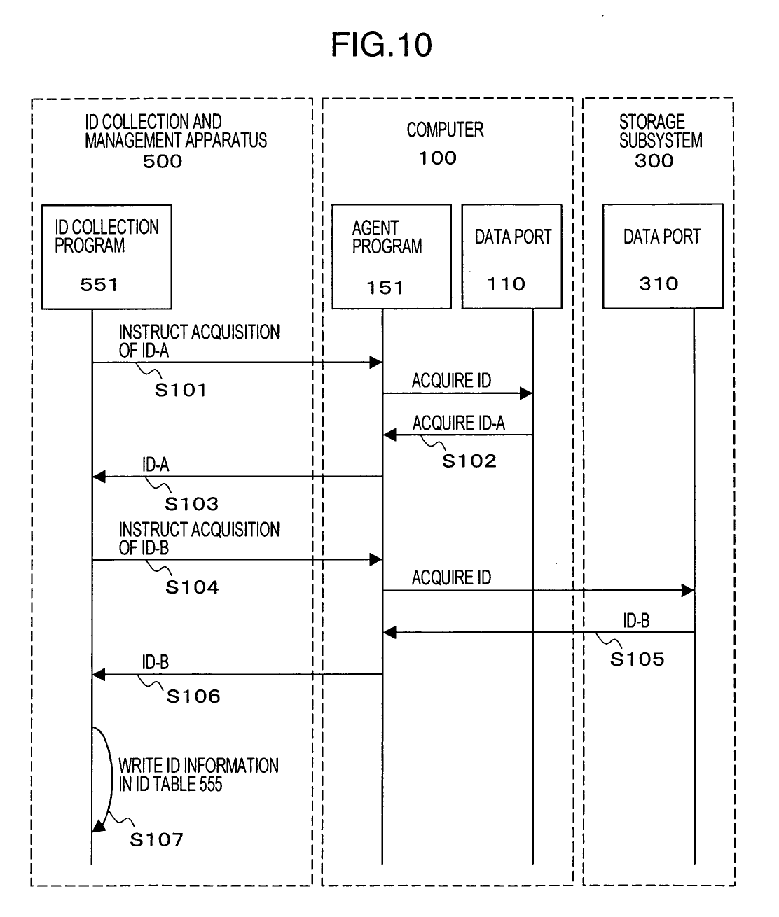

This processing will be described in detail. FIG. 10 is a sequence diagram of the ID collection processing for the ID collection program 551 to collect the IDs of the computer 100.

The ID collection program 551 acquires one piece of access information from the list of agent locators 556 to the agent program 151 (S101).

Here, the ID collection program 551 begins the possessing when it is instructed by the manager of the system through the input unit 520 or by starting up periodically.

The ID collection program 551 makes an access to the agent program 151 specified with the access information, through the management port 510 of the ID collection and management apparatus 500 and the management port 120 of the computer 100, and instructs (S101) acquisition of the ID (hereinafter, called to as the “ID-A”) of the data port 110 of itself of the computer 100.

The agent program 151 of the computer 100 acquires (S102) the ID-A from the data port 110 of the computer 100.

The agent program 151 transmits (S103) the ID-A to the ID collection program 551 through the management port 120 of the computer 100 and the management port 510 of the ID collection and management apparatus 500.

The ID collection program 551 then instructs (S104) the agent program 151, which is specified with the access information acquired at S101, to acquire an ID (hereinafter, called to as the “ID-B”) viewed from the storage subsystem 300 of the computer 100, through the management port 510 of the ID collection and management apparatus 500 and the management port 120 of the computer 100.

Here in the configuration of FIG. 1, for example, the ID-B is converted from the ID-A in the communication relay unit 200. In the configuration of FIG. 5, moreover, the ID-B is finally converted in the communication relay unit 201 or 202. The ID-A and the ID-B have identical contents in the case the computer 100 and the storage subsystem 300 are connected directly without connecting through the communication relay unit 200 or in the case the communication relay unit 200 does not convert the ID.

The acquisition instruction of the ID-B is specified by an instruction to make an access to the storage subsystem 300 and to extract the ID stored in the reply frame.

The agent program 151 transmits the frame to the storage volume 330 through the data port 110 of the computer 100, the communication relay unit 200 and the data port 310 of the storage subsystem 300.

The control program 3515 extracts (S105) the ID information (ID-B) from the frame having reached the data port 310, and stores the ID-B in response.

Here, the frame transmitted by the agent program 151 is not especially limited. For example, the frame may be one which reads the data of the storage volume 330 or one of a special instruction.

In the frame to be used, for example, a partial field of a response is vendor-definable (to have a vendor unique field) like the INQUIRY command of the SCSI. At S105 of this case, the frames are transferred in the following approximate manners.

The agent program 151 sends its own iSCSI Name (ID-A) as a transmitter address in a header unit and the frame storing the iSCSI Name of the communication relay unit 200 as the destination address to the communication relay unit 200. This communication relay unit 200 converts the address and transmitter by using its own relay table 2511, and sends the received frame to the storage subsystem 300.

The storage subsystem 300 discriminates the ID (ID-A) of the communication relay unit 200 or the transmitter of the received frame from the session information. The storage subsystem 300 creates the frame of the INQUIRY command response, stores the ID-B of the discriminated communication relay unit 200 in the vendor unique field of the data portion, and replies.

The communication relay unit 200 having received the frame of the INQUIRY command response refers to the relay table 2511, and replies that frame to the agent program 151 of the computer 100 of the INQUIRY command transmitter.

The agent program 151 received extracts the ID-B from the vendor unique field of the data portion.

The agent program 151 thus having acquired the ID-B transmits (S106) the ID-B to the ID collection program 551 through the management port 120 of the computer 100 and the management port 510 of the ID collection and management apparatus 500.

The ID collection program 551 adds (S107) the ID-A and the ID-B notified from the same agent program 151, in pairs to the ID table 555.

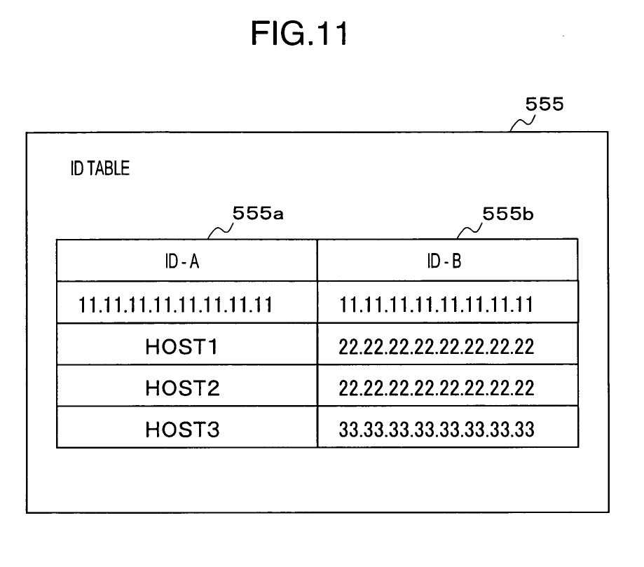

Here will be described the ID table 555. FIG. 11 is a diagram showing one example of the ID table 555.

As shown in FIG. 11, the ID table 555 is provided with an ID-A field 555a and an ID-B field 555b. In this embodiment, the ID-A field 555a stores the iSCSI Name, i.e., the iSCSI ID of the computer 100, and the ID-B field 555b stores the WWN, i.e., the ID of the FC of the computer 100.

In the case of connection without any conversion of IDs such as the case that the computer 100 and the storage subsystem 300 are directly connected, the ID-A field 555a also stores the WWN or the ID of the FC of the computer 100.

The ID collection program 551 performs the above-specified operations sequentially or simultaneously in parallel on all the agent program 151 included in the list of agent locators 556, thereby to collect the pairs of ID-A and ID-B and store them in the ID table 555.

It is desired that the ID collection program 551 provides the UI (User Interface) indicating the contents of the ID table 555 through the output unit 530.

At this time, the ID collection program 551 is desired to have functions to detect that the contents of ID-Bs for a plurality of different ID-As are identical, and then to warn through the output unit 530. Here, the warning may be exemplified by outputting character strings or images as warning messages to the display, or voices. In addition, the warning may also be exemplified by lighting a lamp, by sounding a beeper or by transmitting a mail from the ID collection and management apparatus 500 to the (not-shown) management terminal through the network.

In the example of FIG. 11, both the ID-Bs corresponding to the ID-As “HOST1” and “HOST2” are “22.22.22.22.22.22.22.22”. In other words, the ID-As “HOST1” and “HOST2” are assigned the same ID-B “22.22.22.22.22.22.22.22”. In this case, the ID collection program 551 is desired to have a function to display the warning message which notifies the usage of the same ID.

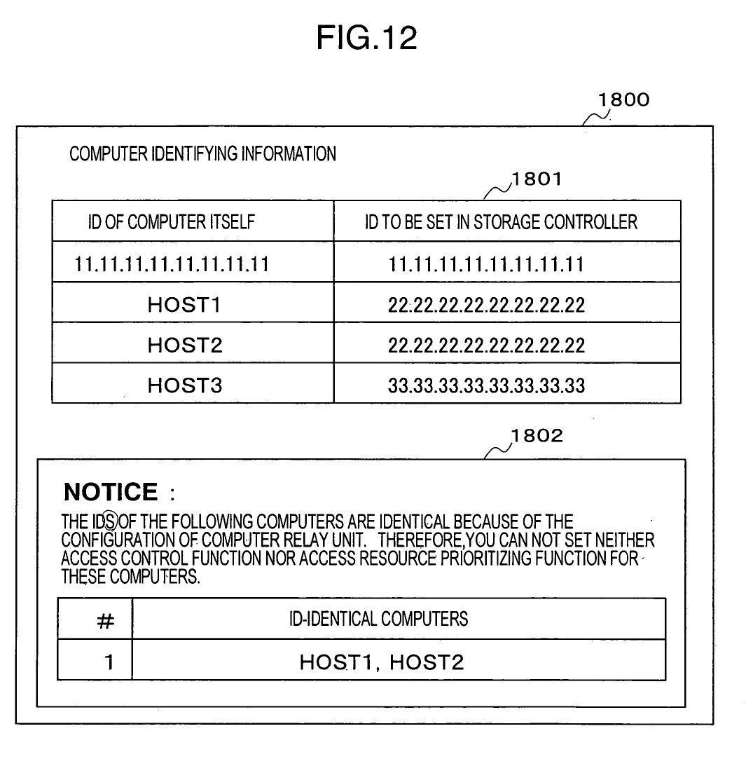

FIG. 12 shows one example, in which the ID collection program 551 displays the contents of the ID table 555 and the warning of the case where the same ID is assigned.

FIG. 12 shows one example of a computer identifying information display screen 1800 or the screen of the UI to be displayed in the output unit 530 by the ID collection program 551.

As shown in FIG. 12, the computer identifying information display screen 1800 is provided with an ID table display portion 1801 which displays the contents of the ID table 555, and a warning message display portion 1802 which displays the warning message.

The manager is enabled to know the contents of the ID table 555 and the situations of the usage of the same ID, if any, by viewing the display of the computer identifying information display screen 1800.

Here in the ID collection processing shown in FIG. 10, the ID-B is acquired after the ID-A was acquired. However, the sequence of acquisition may be reversed, and a parallel acquisition may also be made by sending the instructions of S101 and S104 simultaneously to the agent program 151.

In FIG. 10, moreover, the ID collection program 551 issues the ID acquisition instruction to the agent program 151, and the agent program 151 then acquires each ID and notifies the acquisition. However, the processing sequence is not limited to the aforementioned one. Without awaiting the instruction from the ID collection program 551, for example, the agent program 151 may also acquires the ID-A and the ID-B at the starting time either periodically or at the timing instructed by the manager of that computer 100 and may transmit the acquired IDs to the ID collection program 551. In this case, the ID collection and management apparatus 500 can be configured by omitting the list of agent locators 556.

In FIG. 10, moreover, the ID collection program 551 acquires the ID-A and the ID-B. In addition to these IDs, the ID (hereinafter, called to as the “ID-C”) of the computer 100 such as a host name independent of the data port 110 can also be acquired, and these ID-A, ID-B and ID-C can be registered as one set in the ID table 555.

Here will be described the storage setting processing which sets the storage controller 350 with the access control, the access bandwidth assignment and so on in accordance with the storage setting program 552 by using the IDs thus acquired. The storage setting processing is so realized in the ID collection and management apparatus 500 that the processor 560 loads the storage setting program 552 in the memory 570 and executes the same program.

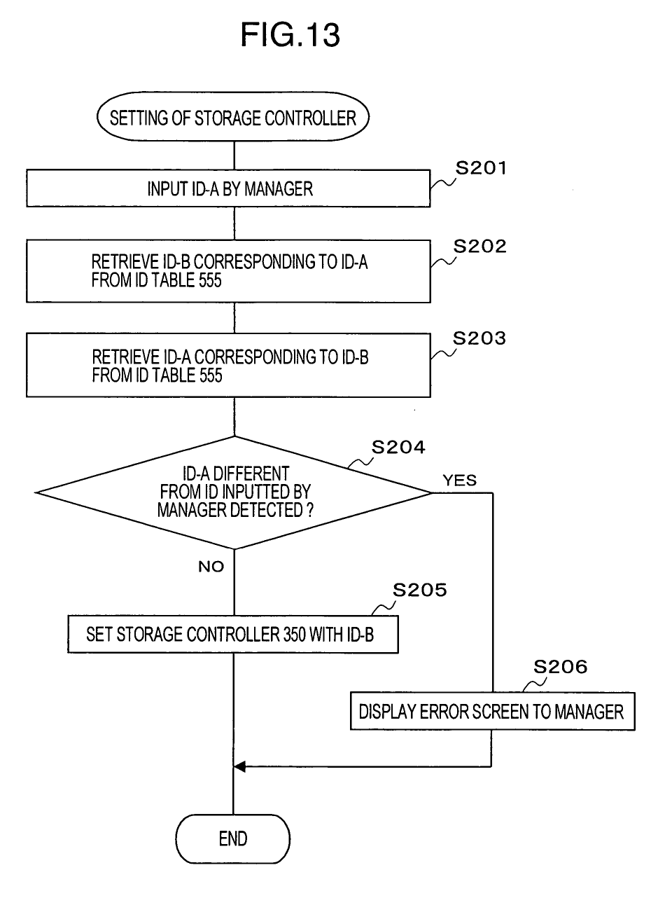

FIG. 13 shows a processing flow of the case, in which the storage setting program 552 performs the storage setting processing.

The input of the ID-A is accepted (S201) from the manager through the input unit 520. This acceptance is made through the UI which is provided by the storage setting program 552 displayed in the input unit 520. This specifies the computer 100 which sets the access control function, the access resource prioritizing function and so on.

The storage setting program 552 retrieves (S202) the ID table 555 and extracts the ID-B corresponding to the ID-A accepted at S201.

The storage setting program 552 retrieves (S203) the ID table 555 again to extract the ID-A corresponding to the ID-B extracted at S202. This is to discriminate whether or not the ID-A having the identical ID-B exists in plurality like the aforementioned case.

The storage setting program 552 decides (S204) whether or not any of the ID-A obtained at S203 is different from the ID-A accepted at S201 from the manager.

In the case any different ID-A is not contained at S204, the ID-A and the ID-B are stored in a correspondence of 1:1. Therefore, the storage setting program 552 sends (S205) an instruction to perform a predetermined setting operation by using the ID-B obtained at S202, to the control program 3515 through the management port 510 of the ID collection and management apparatus 500 and the management port 355 of the storage controller 350.

The control program 3515 having accepted the instruction of S205 updates the contents of the access control table 3511 in the case the instruction is to set the access control function, and the contents of the access resource prioritized table 3512 in the case the instruction is to set the access resource prioritizing function. These are the existing operations so that their detailed description is omitted.

In the case the different ID-A is contained at S204, it is meant that a plurality of ID-As are stored to correspond to the common ID-B, namely, that the plurality of ID-As have the same ID-B. In this case, one computer 100 cannot be set with the ID-B. Therefore, the storage setting program 552 outputs (S206) the error screen 1200 to the output unit 530. At this time, it is desired to display the ID-A acquired at S203 and different from the ID-A inputted at S201, too.

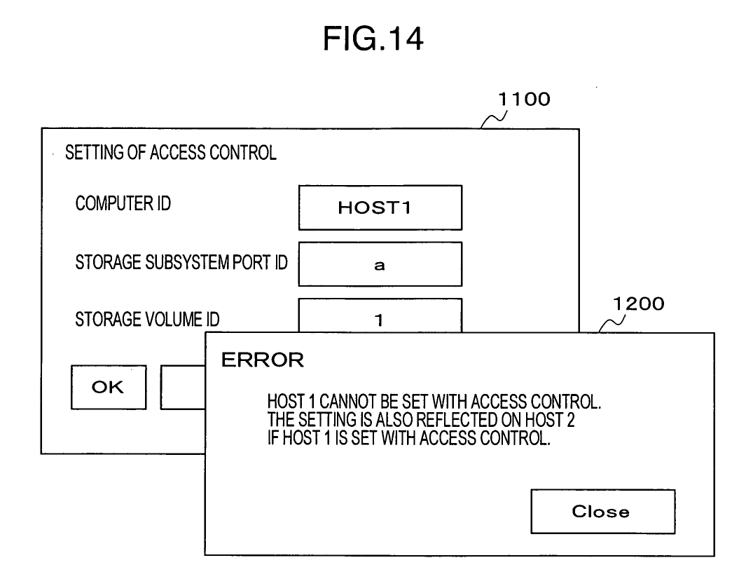

FIG. 14 shows one example of the error screen 1200 to be outputted at S206. The error screen shown in FIG. 14 is one example of the case, in which an error display is made on the screen 1100 of the UI provided at S201 by the storage setting program 552.

The error screen 1200 may be any of the pop-up screens, as shown in FIG. 14, the screen in which an error message is outputted to the same window as the setting screen, and the screen in which the error message is outputted to another frame in the setting screen. Moreover, the output indicating an error may be character strings, as shown, or an image. Alternatively, the error indicating output may be exemplified by lighting a lamp or by sounding a beeper.

The processing of the storage setting program 552 thus far described is specified by the case, in which the contents of the ID table 555 are shown in FIG. 11.

In the case the “HOST3” is set (S201) as the ID-A, the corresponding ID-B is the “33.33.33.33.33.33.33.33” (S202).

The ID-A corresponding to “33.33.33.33.33.33.33.33” is only the “HOST3” (S203 and S204). Therefore, the storage setting program 552 sends an instruction (S205) the control program 3515 of the storage controller 350 to perform the setting operation with the “33.33.33.33.33.33.33.33”.

In the case the “HOST1” is set (S201) as the ID-A, on the other hand, the corresponding ID-B is the “22.22.22.22.22.22.22.22” (S202). In the ID table 555 shown in FIG. 11, the “HOST2” is present (S203 and S204) in addition to the “HOST1” in the ID-A corresponding to the “22.22.22.22.22.22.22.22”. Therefore, the storage setting program 552 transfers the operation of S204 to that of the case, in which a different ID-A is detected, thereby to display the error screen 1200 (S206).

Moreover, the presence/absence of the usage of the same ID may be decided, by extracting the ID-As assigned the same ID-B in advance from the ID table 555 to prepare a table separately, in dependence upon whether or not the ID-A instructed at S201 exists in that table.

In the case of the usage of the same ID, the storage setting processing shown in FIG. 13 stops as an error, but is not limited to the stop. Even with this case, for example, the processing can also be continued, in the case the same setting is made on all the computers 100 assigned the same ID-B or in the case the access can be reliably made to the computer needing it.

Let the case be specifically considered, in which the manager is to set the access control function of the computer having the ID-A of “HOST1” in the environment where the ID-B of the computer having the ID-A of “HOST1” and the ID-B of the computer having the ID-A of “HOST2” are identical, as shown in FIG. 11. In the processing of FIG. 13, the answer of S204 is YES, and the processing ends. This is because the actual setting is made by using the ID-B so that the computer of the “HOST2” having the same ID-B is to be prevented from being set to the same setting.

However, the processing may be proceeded as it is without any problem and any need for the warning or the error message, in the case the same setting is made on all the computers 100 assigned the same ID-B or in the case the access can be reliably made to the computer needing it. In this case, therefore, the storage setting program 552 may not end with the warning or error message but display in the screen that the settings become the same and proceed to S205, even if the answer of S204 is YES.

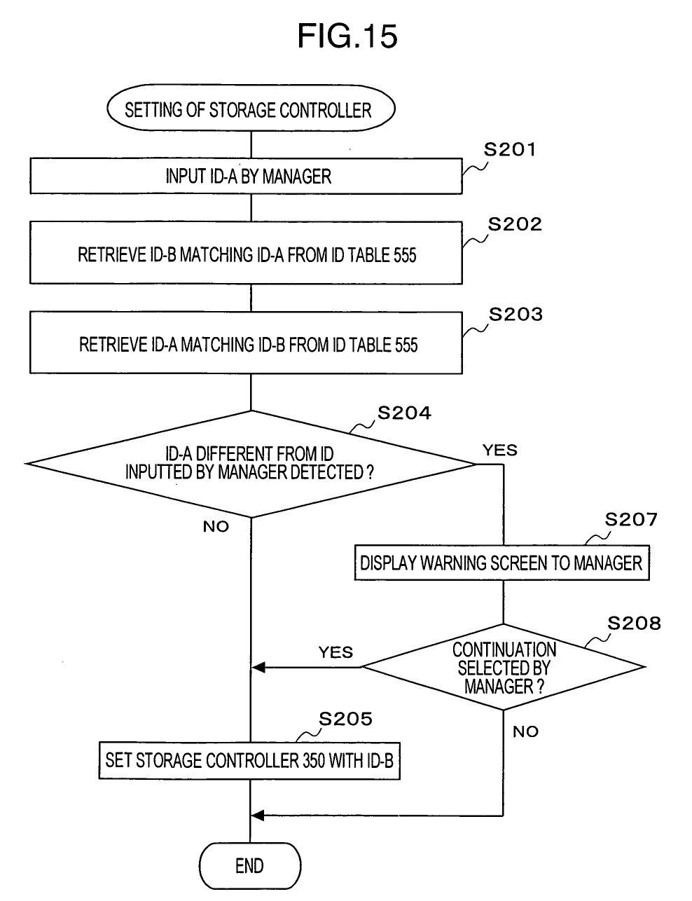

FIG. 15 is a processing flow of a storage setting processing of this case.

The operations from S201 to S205 are similar to those of the flow in FIG. 13. Moreover, the processing of the case, in which the different ID-A is not contained at S204, is also similar.

In the case the different ID-A is contained at S204, on the contrary, the storage setting program 552 outputs (S207) a warning screen 1400 to the output unit 530. This warning screen 1400 notifies the manager of the summarization and urges the manager to input an instruction on whether or not the processing is to be continued. At this time, it is desired to display the ID-A which is different from the ID-A inputted at S201 and obtained at S203.

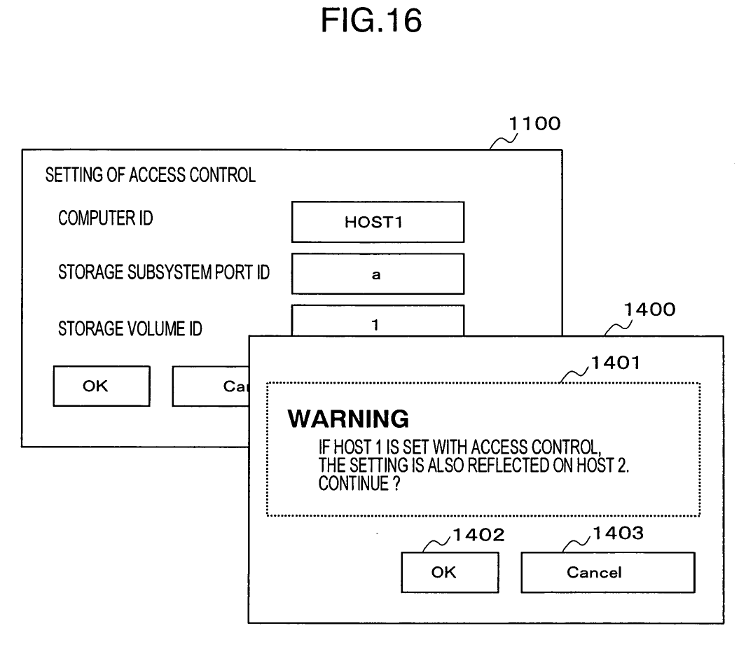

FIG. 16 is a diagram showing one example of the warning screen 1400 to be outputted at S207. This warning screen 1400, as shown, presents one example of the case, in which the warning display is made on a screen 1100 of the UI provided at S201 by the storage setting program 552.

As shown in FIG. 16, the warning screen 1400 is provided with a warning display portion 1401 which displays the warning message, an OK button 1402 which accepts an instruction to continue the processing, and a CANCEL button 1403 which accepts an instruction to stop the processing.

The warning screen 1400 may be a pop-up screen, as shown in FIG. 16, may output the warning message in the same window as the setting screen or may output the warning message to another frame in the setting screen.

The storage setting program 552 accepts (S208) the instruction to continue or stop of the processing from the manager through the input unit 520 when the OK button 1402 or the CANCEL button 1403 is depressed.

Here, the storage setting program 552 transfers to the processing of S205, in the case it accepts the instruction to continue the processing by the depression of the OK button 1402, but ends the processing in the case it accepts the instruction to stop the processing by the depression of the CANCEL button 1403.

In the case it is sufficient if an access to the computer needing it can be reliably made by the access control function, for example, in the setting processing of the storage controller shown in FIG. 13 and FIG. 15, it is unnecessary to judge the usage of the same ID (S203 and S204) thereby to output the error screen (S206) or the warning screen (S207). In short, the storage setting program 552 executes the operation of S205 after the operation of S202 while omitting the operations of S203 and S204. In this case, the ID-Bs of the computers having the ID-As of “HOST1” and “HOST2” are identical. In the case the access control is set in the computer of “HOST1”, this setting is made by using the ID-B so that an access can also be made to the storage volume set from the computer of “HOST2”.

In FIG. 13 and FIG. 15, the description has been made on the case, in which the designation of the ID-A is accepted from the manager to perform the storage setting processing. In the case the aforementioned ID-C is stored in a corresponding manner in the ID table 555, however, the configuration may be made by accepting the designation of the ID-C and performing its processing.

The storage setting processing thus far described is started by accepting the designation of a specific ID-A from the manager, but the processing is not limited thereto. For example, the processing may also be configured such that the storage setting program 552 displays all the ID-As stored in the ID table 555, in the output unit 530 and accepts the designation of the manager.

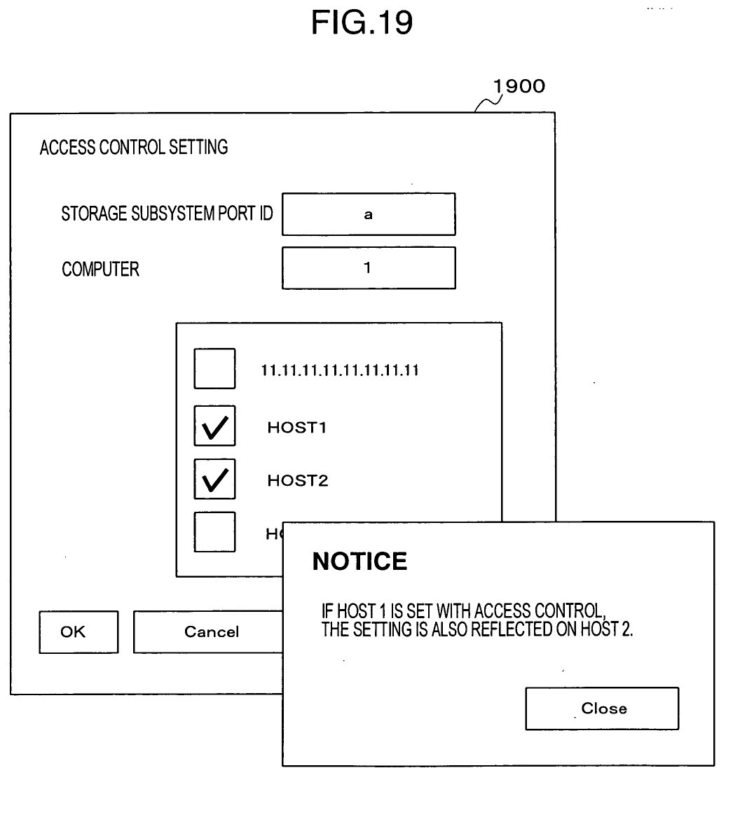

One example of the screen of this case is shown in FIG. 19.

FIG. 19 presents one example of an UI screen 1900, which is created and displayed by the storage setting program 552 so as to accept the input from the manager and to display the computer 100 and the message selected by the manager.

When the instruction to display the screen is accepted from the manager so as to set the access control function, as shown in FIG. 19, the storage setting program 552 refers to the ID table 555 and extracts the selectable computer 100, i.e., the ID-A. The storage setting program 552 constructs the UI screen 1900 (excluding the pop-up screen) shown in FIG. 19, and awaits the selection of the manager.

In response to the instruction received from the manager, the storage setting program 552 performs the operations of S201 to S204 of the storage setting processing shown in FIG. 13, and discriminates the usage of the same ID of the computer 100 identified with the designated ID-A.

In the case the summarization is decided, the storage setting program 552 causes the output unit 530 to display the message of the usage of the same ID in the pop-up screen of the output unit, and brings the other computer 100 assigned the same ID into the selected state. These computers 100 assigned the same ID has the ID-B corresponding to the ID-A designated by the manager.

In the example shown in FIG. 19, for example, the pop-up screen (NOTICE) is displayed, and the “HOST2” is brought into the selected state, when the manager clicks the check box of the “HOST1” to establish the selected state.

In the case the manager releases the selection of the already selected computer 100 through the UI screen 1900 shown in FIG. 19, the storage setting program 552 discriminates the usage of the same ID-B of the selection-released computer 100 by performing the operations of S201 to S204 shown in FIG. 13.

In the case the storage setting program 552 decides the usage of the same ID, it releases the selection of the ID-A of the other computer 100 assigned the same ID.

With the display of the UI screen 1900, the manager can designate or release the computer 100 to be set, at the unit of the computer 100 assigned the same ID. In this case, the ID-C may also be used to designate the computer 100.

The ID collection and management apparatus 500 of this embodiment manages the ID-A and the ID-B in pairs. With the knowledge of the easily manageable ID-A, therefore, the manager is enabled to set the storage controller 350 by using the ID-B corresponding to the ID-A and necessary for setting the storage controller.

Moreover, the ID collection and management apparatus 500 of this embodiment manages the pair of the ID-A and the ID-B for each computer 100 so that it can detect that a plurality of different ID-As are assigned an identical ID-B. In the case the manager makes the setting with those ID-As, the ID collection and management apparatus 500 can make a warning or inhibition against the setting operation.

According to this embodiment, as has been described hereinbefore, the communication relay unit 200 is interposed between the computer 100 and the storage subsystem 300, and the ID of the computer 100 is converted. In this case, the ID collection and management apparatus 500 can be used to set the storage controller 350 correctly with the ID-A (or ID-C) which can be easily managed or acquired.

In the case the ID-As of different computers 100 are to be assigned the common ID-B by the setting of the communication relay unit 200, moreover, the storage setting program 552 outputs the error screen or the warning screen so that the manager can recognize the usage of the same ID. As a result, it is possible to prevent the setting which is not intended by the manager. Alternatively, the control can be made to set at the unit of the computer 100, in which the ID-As are assigned the common ID-B.

In this embodiment, the aforementioned setting can be made with neither the ID conversion information of the communication relay unit 200 nor the information on the connection configuration of the communication relay unit 200 between the computer 100 and the storage subsystem 300.

According to this embodiment, the ID collection and management apparatus can be realized by being conscious of only the computers but neither the intermediate communication relay unit nor their connection relation (i.e., topology).

In the case the same ID is assigned, moreover, an inhibition or warning can be made against the setting operation.

According to the first embodiment of the present invention, as has been described hereinbefore, in the computer system including the communication relay unit which converts the IDs, the various setting operations to be performed for every computers can be done in the storage controller without the ID conversion information in the communication relay unit or the information on the connection relation between the computers and the storage subsystem.

This embodiment has been described on the case, in which the communication protocol on the side of the computer 100 and the communication protocol on the side of the storage subsystem 300 are different. However, the communication protocols to be supported by the communication relay unit 200 may be identical on the side of the computer 100 and on the side of the storage subsystem 300.

Specifically, the communication relay unit 200 may be configured not only by converting the IDs to relay the different protocols as in the FC/IP router exemplified in the embodiment but also by converting the IDs although the common protocols are relayed as in the NAT (Network Address Transfer). A wide variety of devices can be adopted as the communication relay unit 200 of the embodiment, if they have the function to convert the IDs of the computer 100 when the communications from the computer 100 to the storage subsystem 300 are relayed.

In the case a plurality of communication relay units 200 exist between the computer 100 and the storage-subsystem 300, the ID converted by the communication relay unit 200 located the closest to the storage subsystem 300 is the ID-B. In the configuration of FIG. 5, for example, the ID, which is finally converted by the communication relay unit 201 or 202, is the ID-B.

In the case the computer 100 and the storage subsystem 300 are connected directly not through the communication relay unit 200 or in the case the communication relay unit 200 does not convert the IDs, the ID-A and the ID-B have identical contents.

### Second Embodiment

A second embodiment will be described in the following. The computer system of this embodiment has a function to eliminate the usage of the same ID, if any, by creating a new ID.

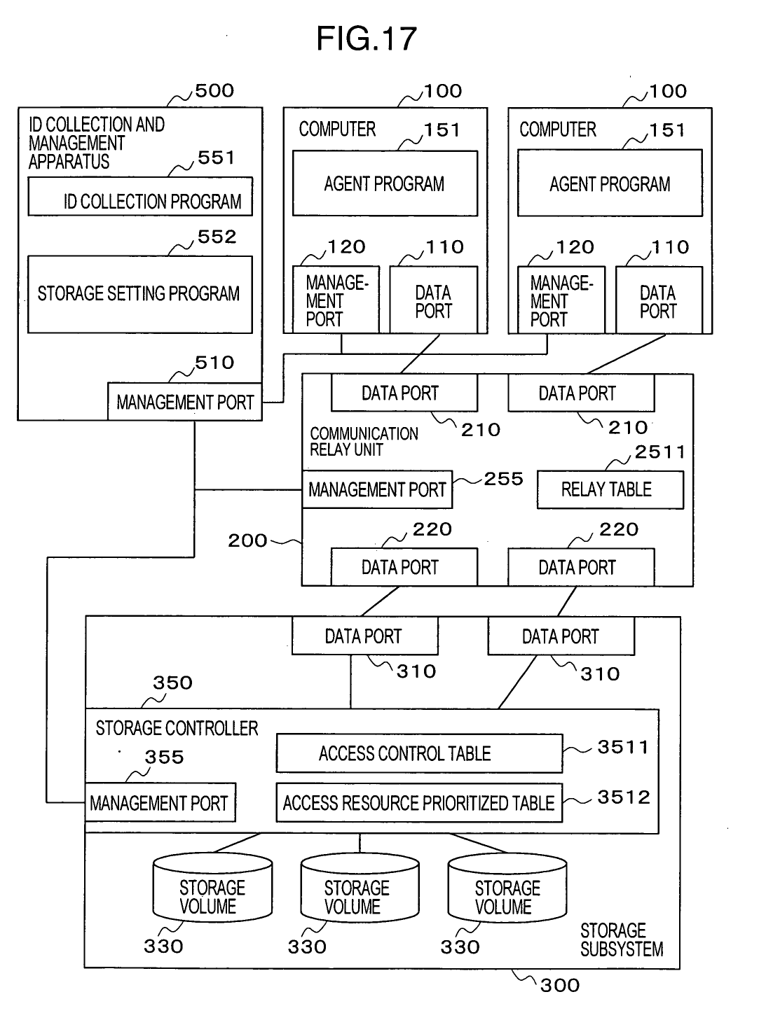

FIG. 17 is a system configuration diagram of a computer system of this embodiment.

The computer system of this embodiment is provided, like the first embodiment, with the computer 100, the communication relay unit 200, the storage subsystem 300 and the ID collection and management apparatus 500.

The individual configuration components of the computer system of this embodiment are basically identical in functions and configurations to the components having the same names as those of the first embodiment. The configurations and functions different from those of the first embodiment will be described in the following.

The storage setting program 552 of the ID collection and management apparatus 500 of this embodiment has such a function in addition to the functions of the storage setting program 552 of the first embodiment as to create an ID newly so that the communication relay controller 250 may be instructed to change the relay table 2511.

Moreover, the management port 510 has an interface function with the communication relay unit 200 in addition to the function of the management port 510 of the first embodiment.

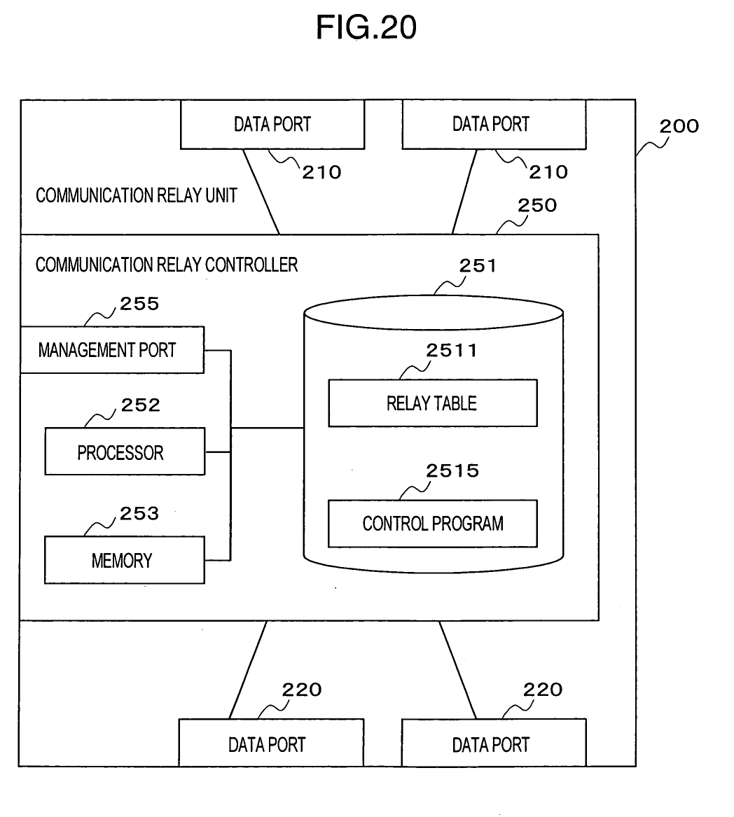

FIG. 20 is a block diagram showing an internal configuration of the communication relay unit 200 of this embodiment.

As shown in FIG. 20, the communication relay unit 200 of this embodiment is provided with the management port 255 having an interface function with the ID collection and management apparatus 500 in addition to the configuration included in the communication relay unit 200 of the first embodiment. Here, the management port 255 is not limited in its number. Moreover, the data ports 210 and 220 and the management port 255 are described as different ones in this embodiment, but one port may also perform all the roles.

Moreover, the control program 2515 of the communication relay unit 200 of this embodiment is provided with a function to update the relay table 2511 in accordance with the instruction of the storage setting program 552 of the ID collection and management apparatus 500, in addition to the functions of the first embodiment.

Here will be described the storage setting processing of this embodiment. This processing is realized by the storage setting program 552.

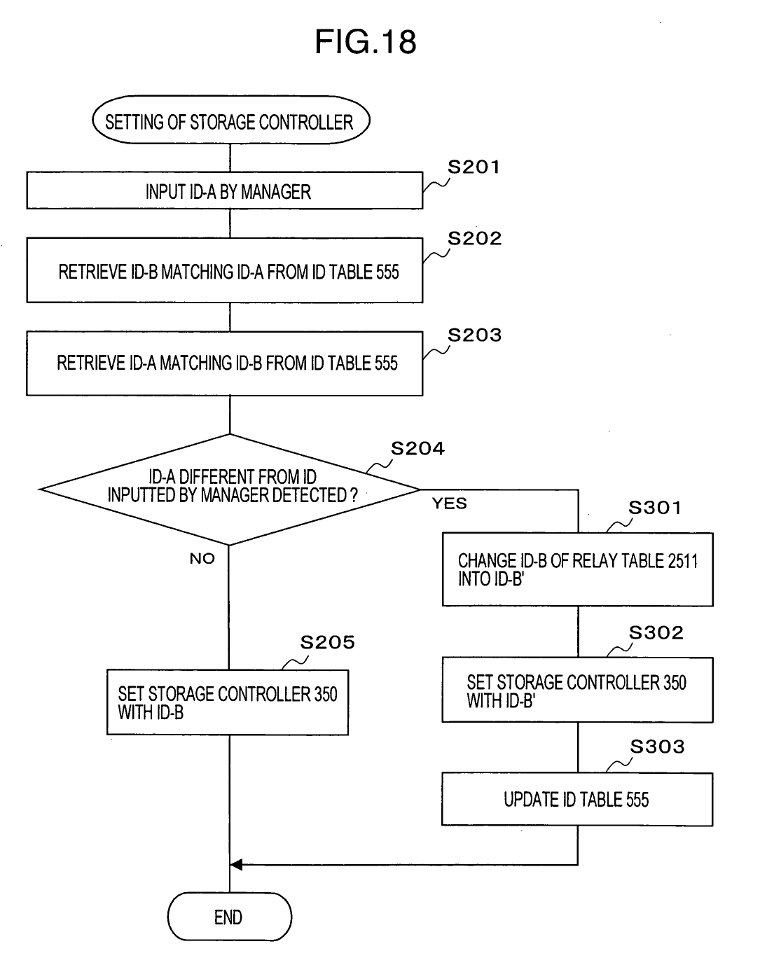

FIG. 18 is a processing flow of the storage setting processing in this embodiment.

In the storage setting processing, moreover, the operations similar to those of the first embodiment are designated by the common reference numerals. Specifically, the operations from S201 to S205 are similar to those of the first embodiment so that they will not be described.

In the case the ID-A, which is different from the ID-A having accepted the instruction at S201 from the manager, is detected at S204, the storage setting program 552 refers at first to the ID table 555 and creates a new ID (hereinafter, called to as the “ID-B′”), which has not been used as the ID-B.

The storage setting program 552 instructs (S301) the control program 2515 of the communication relay controller 250 through the management port 510 of the ID collection and management apparatus 500 and the management port 255 of the communication relay controller 250 to change the ID-B corresponding to the ID-A into the ID-B′.

In response to the instruction of S301, the control program 2515 changes that output ID of record in the relay table 2511, of which the input ID is the ID-A, into the ID-B′, and notifies the storage setting program 552 of the change end. By this processing, the ID-A having accepted the instruction from the manager is so stored in the relay table 2511 as to correspond one-by-one to the ID-B′.

The storage setting program 552 sends (S302) such an instruction to the control program 3515 of the storage controller 350 through the management port 510 of the ID collection and management apparatus 500 and the management port 355 of the storage controller 350 as to set the access control or the access resource prioritized control by using the ID-B′.

The control program 3515 having accepted the instruction of S302 updates the contents of the access control table 3511 or the access resource prioritized table 3512 in accordance with the instruction.

On the other hand, the storage setting program 552 overwrites (S303) the ID-B corresponding to the ID-A of the ID table 555 with the ID-B′.

The processing of the storage setting program 552 of this embodiment thus far described will be specified on the case, in which the ID table 555 has the contents shown in FIG. 11 and in which the relay table 2511 has the contents shown in FIG. 4.

In the case the “HOST2” is set (S201) as the ID-A, the corresponding ID-B is the “22.22.22.22.22.22.22.22” (S202).

The ID-A corresponding to the “22.22.22.22.22.22.22.22” is not only the “HOST2” but also the “HOST1” (S203 and S204).

Therefore, the storage setting program 552 creates the identifier not existing at this point of time, such as “23.23.23.23.23.23.23.23” is created as the ID-B′ in the column of the ID-B of the ID table 555.

After this, the storage setting program 552 instructs the control program 2515 to update (S301) the output ID of record in the relay table 2511 from “22.22.22.22.22.22.22.22” into “23.23.23.23.23.23.23.23”.

Then, the storage setting program 552 instructs the storage controller 350 to set (S302) with the “23.23.23.23.23.23.23.23”. Moreover, the storage setting program 552 updates (S303) that ID-B of record in the ID table 555, of which the ID-A is the “HOST2”, from “22.22.22.22.22.22.22.22” into “23.23.23.23.23.23.23.23”.

The updating of the ID table 555 at S303 is not limited to the aforementioned one which is performed by the overwrite of the storage setting program 552. For example, the updating may also be performed such that the ID collection program 551 recollects the ID information by doing the ID collection processing of the first embodiment, as shown in FIG. 10. In this case, at the end of the operation of S302, the storage setting program 552 instructs the ID collection program 551 to execute the aforementioned operation.

In the processing flow thus far described, moreover, the operation of S303 is executed after S302. However, this processing order may be any in the storage setting processing of this embodiment. Specifically, the operations may be reversed in order or simultaneously executed in parallel.

Thus according to this embodiment, the storage controller 350 can be correctly set like the first embodiment with the easily managed or acquired ID-A (or ID-C) by the ID collection and management apparatus 500.

Even in the case the ID-As of different computers 100 are assigned the common ID-B by the setting of the communication relay unit 200, the identifiers can be prevented from being summarized to realize the settings of every computer 100 by changing the setting of the communication relay unit 200.

Here, the ID collection and management apparatus 500 of the first and second embodiments thus far described can also be used in the computer system, in which the computer 100 and the storage subsystem 300 are connected directly without connecting through the communication relay unit 200.

1. An ID collection and management apparatus which manages identifiers of computers in a computer system including said computers and a storage system which provides said computers with a storage volume, comprising:
a first ID acquisition unit which acquires first IDs which are IDs of a data port for said computers to transmit/receive data with said storage volume;
a second ID acquisition unit which acquires second IDs to be recognized as the IDs of said computers by said storage system; and
an ID management unit which manages said first IDs and said second IDs in a corresponding manner for each of said computers.

2. An ID collection and management apparatus according to claim 1, further comprising:
a second ID extraction unit which extracts said second IDs managed in a manner to correspond to the designated one of said first IDs by said ID management unit;
a first ID extraction unit which extracts such first IDs (hereinafter, called to as the “other first IDs”) other than said designated first ID as are managed by said ID management unit in a manner to correspond to the second IDs identical to the second IDs extracted by said second ID extraction unit; and
a message issuing unit which issues a message in the case said other first IDs are extracted by said first ID extraction unit.

3. An ID collection and management apparatus according to claim 2, further comprising:
an ID sending unit which sends said second IDs extracted by said second ID extraction unit, in the case said other first IDs are not extracted by said first ID extraction unit.

4. An ID collection and management apparatus according to claim 3, further comprising:
an acceptance unit which is activated when a message is issued by said message issuing unit, to accept a processing continuing instruction from a manager,
wherein said ID sending unit sends said second IDs extracted by said second ID extraction unit, to said storage system, in the case said acceptance unit accepts the processing continuing instruction.

5. An ID collection and management apparatus which manages the identifiers of computers in a computer system having said computers and a storage system connected through a communication relay unit, comprising:
a first ID acquisition unit which acquires first IDs which are IDs of a data port for said computers to transmit/receive data with a storage volume provided by said storage system;
a second ID acquisition unit which acquires second IDs provided as the IDs of said computers to said storage system by said communication relay unit;
an ID management unit which manages said first IDs and said second IDs in a corresponding manner for each of said computers;
a second ID extraction unit which extracts the second IDs managed in a manner to correspond to the designated one of the first IDs by said ID management unit;
a first ID extraction unit which extracts all the first IDs that are managed by said ID management unit in a manner to correspond to the second IDs identical to the second IDs extracted by said second ID extraction unit;
a judgment unit which judges whether or not others than said designated first ID are contained in the first IDs extracted by said first ID extraction unit;
an ID sending unit which sends said second IDs extracted by said second ID extraction unit to said storage system, in a case it is judged by said judgment unit that the first IDs other than said designated first ID are not contained;
a second ID creation unit which creates a new second ID not managed by said ID management unit, in a case it is judged by said judgment unit that the first IDs other than said designated first ID are contained;
an instruction sending unit which instructs said communication relay unit to manage said new second ID in a manner to correspond to said designated first ID; and
an ID replacing unit which replaces said second IDs managed by said ID management unit in a manner to correspond to said designated first ID, by the new second ID created by said second ID creation unit.

6. An ID collection and management apparatus which manages the identifiers of computers in a computer system including said computers and a storage system which provides said computers with a storage volume, comprising:
a processor and a memory,
wherein said processor
acquires first IDs of a data port for said computers to transmit/receive data with said storage volume;
acquires second IDs to be recognized as the IDs of said computers by said storage system;
store to manage said first IDs and said second IDs as an ID table in a corresponding manner for each of said computers; and
extracts the second IDs managed by said ID table in a manner to correspond to said designated first IDs.

7. A program which functions a managing computer, which manages the identifiers of computers in a computer system including said computers and a storage system which provides said computers with a storage volume, as:
a first ID acquisition means which acquires first IDs which are IDs of a data port for said computers to transmit/receive data with said storage volume;
a second ID acquisition means which acquires second IDs to be recognized as the IDs of said computers by said storage system;
a ID management means which manages said first IDs and said second IDs in a corresponding manner for each of said computers;
a second ID extraction means which extracts the second IDs managed in a manner to correspond to said designated first IDs by said ID management unit;
a first ID extraction means which extracts all the first IDs that are managed by said ID management means in a manner to correspond to the second IDs identical to the second IDs extracted by said second ID extraction means;
a judgment means which judges whether or not others than said designated first ID are contained in the first IDs extracted by said first ID extraction means;
a ID sending means which sends said second IDs extracted by said second ID extraction means to said storage system, in a case it is judged by said judgment means that the first IDs other than said designated first ID are not contained; and
a warning issuing means which issues a warning, in the case it is judged by said judgment means that the first IDs other than said designated first ID are contained.

8. A program according to claim 7,
wherein said managing computer is further functioned as:
a acceptance means which is activated when a warning is issued by said warning issuing means, to accept a processing continuing instruction from a manager, and
wherein said ID sending means is cased to send said second IDs extracted by said second ID extraction means, to said storage system, in the case said acceptance means accepts the processing continuing instruction the usage of the same ID

9. A program which functions a managing computer, which manages the identifiers of computers in a computer system having said computers and a storage system connected through a communication relay unit, as:
a first ID acquisition means which acquires first IDs which are IDs of a data port for said computers to transmit/receive data with a storage volume provided by said storage system;
a second ID acquisition means which acquires second IDs provided as the IDs of said computers to said storage system by said communication relay unit;
a ID management means which manages said first IDs and said second IDs in a corresponding manner for each of said computers;
a second ID extraction means which extracts the second IDs managed in a manner to correspond to the designated one of the first IDs by said ID management means;
a first ID extraction means which extracts all the first IDs that are managed by said ID management means in a manner to correspond to the second IDs identical to the second IDs extracted by said second ID extraction means;
a judgment means which judges whether or not others than said designated first ID are contained in the first IDs extracted by said first ID extraction means;
a ID sending means which sends said second IDs extracted by said second ID extraction means to said storage system, in the case it is judged by said judgment means that the first IDs other than said designated first ID are not contained;
a second ID creation means which creates a new second ID not managed by said ID management means, in the case it is judged by said judgment means that the first IDs other than said designated first ID are contained;
a instruction sending means which instructs said communication relay unit to manage said new second ID in a manner to correspond to said designated first ID; and
ID replacing means which replaces said second IDs accepted in said ID accepting means and managed by said ID management means in a manner to correspond to said designated first ID, by the new second ID created by said second ID creation means.

10. A computer system comprising computers, a storage system, a communication relay unit and a management computer,
wherein said storage system comprises:
a storage volume to be provided for said computers; and
a storage control unit which controls an access to each of said computers,
wherein said computers comprise data ports acting as interfaces to transmit/receive data with said storage volume,
wherein said communication relay unit includes a relay unit which relays the transmission/reception of the data between said computers and said storage system, and
wherein said management computer comprises:
a first ID acquisition unit which acquires first IDs which are IDs of said data ports of said computers;
a second ID acquisition unit which acquires second IDs provided as the IDs of said computers to said storage system by said communication relay unit;
an ID management unit which manages said first IDs and said second IDs in a corresponding manner for each of said computers;
a second ID extraction unit which extracts the second IDs managed in a manner to correspond to the designated one of the first IDs by said ID management unit; and
an ID sending unit which sends said second IDs extracted by said second ID extraction unit to said storage system.

11. A computer system according to claim 10,
wherein said second ID acquisition unit issues an instruction to said computers to send a frame to said storage system, and
wherein said computers extract said second IDs from the reply frame replied from said storage system to said frame, and send the same to said management computer.

12. A computer system according to claim 10,
wherein a communication protocol between said communication relay unit and said computers is different from a communication protocol between said communication relay unit and said storage system.

13. A computer system according to claim 12,
wherein the communication protocol between said communication relay unit and said computers is the iSCSI, whereas the communication protocol between said communication relay unit and said storage system is a fibre channel.

14. A computer system according to claim 11,
wherein said storage system makes a control on said access by using said second IDs sent from said ID sending unit.

15. A computer system comprising computers, a storage system and a communication relay unit,
wherein said storage system comprises:
a storage volume to be provided for said computers; and
a storage control unit which controls an access to each of said computers,
a first ID acquisition unit which acquires first IDs which are IDs of said data ports of said computers;
a second ID acquisition unit which acquires second IDs provided as the IDs of said computers to said storage system by said communication relay unit;
an ID management unit which manages said first IDs and said second IDs in a corresponding manner for each of said computers; and
a second ID extraction unit which extracts the second IDs managed in a manner to correspond to the designated one of the first IDs by said ID management unit,
wherein said computers include data ports acting as interfaces to transmit/receive data with said storage volume, and
wherein said communication relay unit includes a relay unit which relays the transmission/reception of the data between said computers and said storage system.

16. An ID collection and management method which collects and manages the identifiers of computers in a computer system including said computers and a storage system which provides said computers with a storage volume, comprising:
acquiring a first ID which are IDs of a data port for said computers to transmit/receive data with said storage volume;
acquiring a second ID to be recognized as the IDs of said computers by said storage system; and
managing said first IDs and said second IDs in an ID table in a corresponding manner for each of said computers.

17. An ID collection and management method according to claim 16, further comprising:
extracting a second ID managed in a manner to correspond to the designated one of said first IDs by said ID table;
extracting all the first IDs managed by said ID table in a manner to correspond to the second IDs identical to the second IDs extracted by said second ID extraction unit;
judging whether or not others than said designated first ID are contained in said extracted first IDs;
sending said extracted second IDs to said storage system, in the case it is judged that the first IDs other than said designated first ID are not contained; and
issuing a warning, in the case it is judged that the first IDs other than said designated first ID are contained.

18. An ID collection and management method according to claim 17, further comprising:
sending said extracted second IDs to said storage system, in the case an instruction to continue the processing from a manager is accepted when said warning is issued.

19. An ID collection and management method according to claim 16, further comprising:
acquiring the IDs replied to a frame by said storage system and extracted from the frame, by issuing such an instruction to said computers having acquired said first IDs as to send said frame to said storage system and by receiving said replied and extracted IDs from said computers.

20. A computer system comprising a plurality of computers, a storage system, a plurality of communication relay units and a management apparatus,
wherein said storage system comprises:
a storage volume to be provided for said computers;
a storage control unit which controls an access to such each of said computers as is discriminated with the received ID; and
storage data ports which act as interfaces to transmit/receive data individually with said computers,
wherein said computers individually comprise: computer data ports acting as interfaces to transmit/receive data with said storage system;
an agent location unit which acquires the first IDs which are IDs of the computer data ports of said computers and which extracts and acquires the second IDs contained in the response to the frame sent through said computer data ports to said storage volume and recognized as the IDs of said computers by said storage system,
wherein said communication relay units individually include relay units which relays the transmission/reception of the data between said plural computers and said storage system, and
wherein said ID collection and management apparatus comprises:
an ID acquisition unit which acquires said first IDs and said second IDs from the agent location units of said plural computers;
an ID management unit which manages said first IDs and said second IDs acquired by said ID acquisition unit, in a corresponding manner for each of said computers; and
a storage setting unit, and
wherein said storage setting unit:
extracts said second IDs managed in a manner to correspond to the designated first IDs by said ID management unit;
retrieves said ID management unit;
confirms whether or not such first IDs (hereinafter, called to as the “other first IDs”) other than said designated first ID as are managed by said ID management unit in a manner to correspond to the second IDs identical to the second IDs extracted by said second ID extraction unit exist in said ID management unit;
issues a warning, in the case said other first IDs are not detected; and
sends said extracted second IDs to said storage control unit, in the case said other first IDs are not detected from said first IDs managed by said ID management unit.
